(19) United States
(12) Patent Application Publication
(10) Pub. No.: US 2026/0109230 A1
(43) Pub. Date: Apr. 23, 2026

(54) METHOD AND SYSTEM FOR CHANGING LANGUAGES IN REAL-TIME

(71) Applicants: HYUNDAI MOTOR COMPANY, Seoul (KR); KIA CORPORATION, Seoul (KR)

(72) Inventor: Bo Hyun Kim, Hwaseong-si (KR)

(73) Assignees: HYUNDAI MOTOR COMPANY, Seoul (KR); KIA CORPORATION, Seoul (KR)

(21) Appl. No.: 19/242,776

(22) Filed: Jun. 18, 2025

(30) Foreign Application Priority Data
Oct. 17, 2024 (KR) 10-2024-0141765

(51) Int. Cl. B60K 35/90; B60K 35/10; G10L 15/00

(52) U.S. Cl. CPC B60K 35/90; B60K 35/10; G10L 15/005; B60K 2360/148

(57) ABSTRACT

A real-time language changing method, performed by a computing device comprising at least one processor, includes selecting candidate languages based on at least one of a wake-up word uttered by a user, a location of a vehicle, or language setting of the vehicle. The method also includes transmitting information about a speech utterance of the user and the candidate languages to a server. The method additionally includes receiving a candidate language-specific response to the speech utterance of the user from the server. The method further includes changing the language setting of the vehicle based on a selection made by the user for the candidate language-specific response.

### CROSS-REFERENCE TO RELATED APPLICATION

This application claims the benefit of and priority to Korean Patent Application No. 10-2024-0141765, filed on Oct. 17, 2024, the entire contents of which are hereby incorporated herein by reference.

### TECHNICAL FIELD

The present disclosure relates to a method and device for changing a language in real-time.

### BACKGROUND

The content described in this Background section merely provides background information related to the present disclosure and does not necessarily constitute prior art.

A speech recognition system refers to a hardware, software, or system that automatically recognizes linguistic meaning from a speech signal. Such speech recognition system may be used in a product such as an AI speaker or a speech recognition keyboard. The speech recognition system is typically classified as a word recognition system, a continuous speech recognition system, and/or a speaker recognition system. The word recognition system and the continuous speech recognition system may be considered as a narrow-scope speech recognition system that gives commands or inputs information into a computer through speech. A speaker recognition system is a system that determines or identifies a person who uttered the speech, and is widely used in applications such as registrant access control or criminal investigations.

Speech recognition systems are expanding its applications across various fields. In particular, the importance of speech recognition systems is increasingly prominent with the development of artificial intelligence (AI) technology.

A speech recognition system for a vehicle generally controls the vehicle and infotainment system based on speech recognition and natural-language processing technology, and provides guidance on vehicle-related terms and usage. However, when a driver crosses a border or drives through a region where multiple languages are spoken, there is a challenge of changing the speech recognition language in real-time or detecting the language used by the driver to improve speech recognition accuracy without manual settings. Conventionally, a language-specific speech recognition engine determines and changes the language of the user's speech based on the confidence score of the user's speech recognition. However, the process of determining and changing the language for the user's speech requires activating speech recognition engines for all languages, making the system inefficient.

### SUMMARY

In view of the above, an objective of the present disclosure is to determine a language used by a driver in real-time without requiring the driver to manually change the language when the driver's situation requires a change in the speech recognition language in real-time.

The objectives to be achieved by the present disclosure are not limited to the above-mentioned objectives. Other objectives not mentioned herein should be more clearly understood by those having ordinary skill in the art from the following description.

According to an embodiment, a real-time language changing method is provided. The real-time language changing method may be performed by a computing device comprising at least one processor. The real-time language changing method includes selecting candidate languages based on at least one of a wake-up word uttered by a user, a location of a vehicle, or language setting of the vehicle. The real-time language changing method also includes transmitting information about a speech utterance of the user and the candidate languages to a server. The real-time language changing method additionally includes receiving a candidate language-specific response to the speech utterance of the user from the server. The real-time language changing method further includes changing the language setting of the vehicle based on a selection made by the user for the candidate language-specific response.

According to another embodiment, a device is provided. The device includes at least one memory configured to store computer-readable instructions and at least one processor configured to execute the computer readable instructions to: select candidate languages based on at least one of a wake-up word uttered by a user, a location of a vehicle, or language setting of the vehicle; transmit information about a speech utterance of the user and the candidate languages to a server; receive a candidate language-specific response to the speech utterance of the user from the server; and change the language setting of the vehicle based on a selection made by the user for the candidate language-specific response.

According to still another embodiment, a non-transitory recording medium or media storing computer-readable instructions is provided. The computer-readable instructions, when executed by at least one processor, cause the at least one processor to: select candidate languages based on at least one of a wake-up word uttered by a user, a location of a vehicle, or language setting of the vehicle; transmit information about a speech utterance of the user and the candidate languages to a server; receive a candidate language-specific response to the speech utterance of the user from the server; and change the language setting of the vehicle based on a selection made by the user for the candidate language-specific response.

According to embodiments of the present disclosure, when executing speech recognition, a speech recognition result set in real-time is acquired from a vehicle, so that a language can be changed to a language of a speech recognition result selected by a user, when the language of the speech recognition result selected by the user is different from a current language set in an Audio Video Navigation Telematics (AVNT) system.

According to embodiments of the present disclosure, a speech recognition engine is optimized to a user's actual language, so that speech recognition accuracy can be increased and the malfunction of a system can be reduced.

According to embodiments of the present disclosure, each user can immediately use a system in a preferred language, in an environment where various users access the system, such as a vehicle sharing service or a rental car.

According to embodiments of the present disclosure, it can provide customized services tailored to the user's language as well as the user's preferences and driving habits, and provide a personalized experience.

According to embodiments of the present disclosure, by providing only the recognition results of the speech recognition engines according to the default language of a wake-up engine, GPS, and AVNT system and setting the language of the provided results as the default language, a computation amount required to change the default language can be reduced.

Effects of the present disclosure are not limited to the above-mentioned effects, and other effects not mentioned above should be more clearly understood by those having ordinary skill in the art from the following description.

### BRIEF DESCRIPTION OF THE DRAWINGS

FIG. 1 is a block diagram schematically showing a system for changing a language in real-time according to one embodiment of the present disclosure.

FIG. 2 is a block diagram schematically illustrating part of the configuration of a real-time language changing system included in a vehicle according to one embodiment of the present disclosure.

FIG. 3 is a block diagram schematically showing a server according to one embodiment of the present disclosure.

FIG. 4A is a block diagram illustrating an operation in which a wake-up engine is activated to select a first candidate language according to one embodiment of the present disclosure.

FIG. 4B is a block diagram illustrating an operation in which a GPS is activated to select a second candidate language according to one embodiment of the present disclosure.

FIG. 4C is a block diagram illustrating an operation in which an AVNT system is activated to select a third candidate language according to one embodiment of the present disclosure.

FIG. 4D is a block diagram illustrating an operation in which a vehicle selects a finally set candidate language according to one embodiment of the present disclosure.

FIG. 5 is a block diagram illustrating an operation in which a server receives a candidate language from a vehicle according to one embodiment of the present disclosure.

FIG. 6 is a flowchart showing a process of changing a language in real-time according to one embodiment of the present disclosure.

FIG. 7 is a block diagram schematically illustrating an example computing device that may be used to implement a method or device according to the present disclosure.

The drawings described herein are for illustration purposes only and are not intended to limit the scope of the present disclosure in any way.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

Hereinafter, embodiments of the present disclosure are described in detail with reference to the accompanying drawings. In the following description, when a component, device, element, or the like of the present disclosure is described as having a purpose or performing an operation, function, or the like, the component, device, or element should be considered herein as being “configured to” meet that purpose or perform that operation or function.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

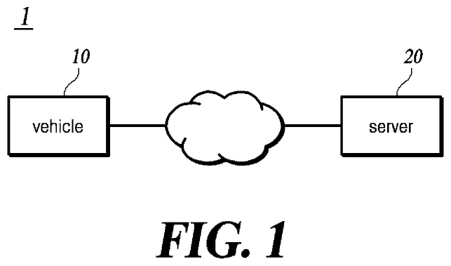

FIG. 1 is a block diagram schematically showing a system 1 for changing a language in real-time according to one embodiment of the present disclosure. Components shown in FIG. 1 represent functionally distinct elements, and one or more component may be implemented in a form that is integrated with each other in an actual physical environment.

The real-time language changing system 1 includes a vehicle 10 and a server 20. The real-time language changing system 1 may determine a user's language in real-time. The real-time language changing system 1 may increase speech recognition accuracy by determining a language used by the user in real-time without requiring the user to manually change the language.

The vehicle 10 may be connected to the server 20 that provides a function or a service related to the vehicle 10 through a mobile or wireless network such as Long Term Evolution (LTE), 5G, or Wi-Fi., for example.

The real-time language changing system 1 may be triggered by at least one of starting the vehicle 10, adjusting a seat, or changing a user's profile. When the vehicle 10 is started, the driver's seat is adjusted, or the user's profile is changed, it may be considered that a change has occurred in the user, i.e. the driver.

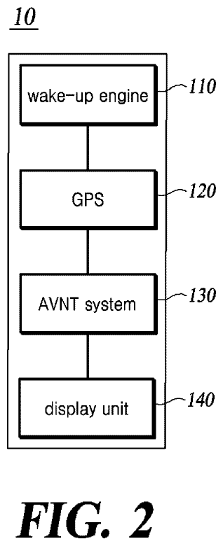

FIG. 2 is a block diagram schematically illustrating part of the configuration of the real-time language changing system 1 included in the vehicle 10 according to one embodiment of the present disclosure.

The vehicle 10 may include all or part of a wake-up engine 110, a Global Positioning System (GPS) 120, an AVNT system 130, and a display unit 140.

The wake-up engine 110 may activate the system by using a user's speech in a speech recognition system. The wake-up engine 110 may have the function of activating a speech recognition system by recognizing specific words or phrases called hot words or wake-up words. For example, “Hey Hyundai”, “OK Hyundai”, etc. may be used as the wake-up word. The wake-up engine 110 may distinguish between noise and specific words based on pronunciation patterns. For example, if the user says, “The weather is so clear today, isn't it? Hey Hyundai,” the wake-up engine 110 is not activated by the speech utterance “The weather is so clear today, isn't it?” because it is trained on the specific word “Hey Hyundai.”

The wake-up engine 110 is designed to operate at low power because it should continuously monitor the user's speech. The wake-up engine 110 may recognize the user's speech and then provide a customized response. The customized response is useful in a home AI speaker or in a vehicle. The wake-up engine 110 may support various languages and pronunciations and may recognize the wake-up word even if the user pronounces it slightly differently. The wake-up engine 110 may also include a function to enhance security by recognizing only a specific voice. For example, only voices registered by the user may be set to be recognized as the wake-up word.

The GPS 120 is a system that uses a satellite signal to track the location of the vehicle in real-time and guide a direction. The GPS 120 may increase user convenience and safety. For example, the GPS 120 may provide an optimal route to a destination.

The GPS 120 may identify a current location of the vehicle 10 in real-time and displays it on a map. The GPS 120 may provide the optimal route to the destination and may provide a direction, a turning point, and an expected arrival time while driving. When the user sets a route, the GPS 120 may analyze real-time data such as traffic conditions, road closures, and accidents to suggest the optimal route. Further, the GPS 120 may collect real-time traffic information such as traffic congestion, accidents, and road construction to automatically update the route. Using the updated information, the driver may avoid traffic congestion and may select a faster route. The GPS 120 may provide a speech guidance function so that the driver may receive route guidance without looking at a screen while driving. The speech guidance may mean information such as turning points and arrival times.

The AVNT system 130 is an infotainment system that may provide integrated audio, video, navigation, and telematics functions within the vehicle 10. The AVNT system 130 may provide various audio contents such as radio, music playback, pod casts, and audio books. The AVNT system 130 may provide a video playback function, such as a movie, through the screen. The AVNT system 130 may provide a function for tracking the current location of the vehicle 10 and guiding the optimal route. Further, the AVNT system 130 may provide a function that allows the user to set the language of the system. Thus, the user may check the language that is currently set in the AVNT system 130 and may change it to a language desired by the user. In addition, the AVNT system 130 may detect an emergency situation and may send a rescue request in the event of an accident.

The display unit 140 may be configured as a physical device including, for example, one of a liquid-crystal display (LCD), an organic light-emitting diode (OLED) display, a light-emitting diode (LED) display, a flat panel display, or a transparent display. However, the present disclosure is not limited thereto.

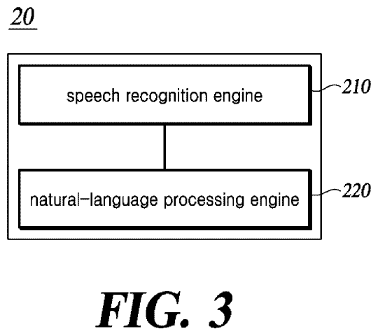

FIG. 3 is a block diagram schematically showing the server 20 according to one embodiment of the present disclosure.

The server 20 may include all or part of a speech recognition engine 210 and a natural-language processing engine 220.

The speech recognition engine 210 may acquire the speech utterance of a speaker received by a microphone in the vehicle and converts the speech utterance into text using a speech to text (STT) engine. The STT engine may apply a speech recognition algorithm or a deep learning model to a speech signal indicating the user's speech utterance to convert the speech signal into text. In this regard, the speaker's speech utterance is the speech signal, and the speech recognition engine 210 may receive a speech signal corresponding to the speaker's speech utterance.

The natural-language processing engine 220 may understand and identify the speaker's speech utterance by classifying the speaker's intended meaning and slot of the speaker's speech utterance. The speaker's intended meaning may be classified as, for example, making a phone call, searching for a destination, playing a radio broadcast, explaining a route, or playing a song. The speaker's intended meaning may be classified into various domains such as changing the destination, adding a stopover, changing a stopover, or making a phone call, and an out-of-domain (OOD) instruction.

The slot may mean an object required to provide information according to the speaker's intended meaning. The slot may be predefined for each speaker's intended meaning. As an example, the slot for a routing intent may be the destination or the stopover. A keyword corresponding to the slot may be home or business.

The natural-language processing engine 220 may extract information such as a domain, an entity name, and a speech act from an input sentence using, for example, a Natural Language Understanding (NLU) engine. The natural-language processing engine 220 may further extract intent and slots based on the extraction result.

The domain may include information for identifying the subject of the speaker's speech utterance. For example, domains representing various subjects such as vehicle control, information provision, text transmission, and navigation functions may be determined based on the input sentence.

The entity name may refer to proper nouns such as people's names, place names, organization names, times, dates, and currencies. Named entity recognition (NER) is the task of identifying the entity name in a sentence and determining the type of the identified entity name. The NER may be used to extract an important keyword from the sentence and understand the meaning of the sentence.

Speech act analysis may refer to the task of analyzing the intention of utterance. Speech act analysis may be used to determine the intention of the speech utterance, such as whether the user is asking a question, making a request, responding, or expressing an emotional expression.

Information such as a domain, an entity name, and a speech act may be used for at least one of the following operations: classifying the speaker's intended meaning, determining the slot, or generating a response to the speaker's speech utterance. For example, the NLU engine may segment the input sentence into morpheme units, project the morphemes into a vector space, group the projected vectors to classify intent according to the input sentence, and extract other components corresponding to slots of intents in the input sentence as entities.

As an example, if the input sentence is “Please call Kim Cheol-su,” the NLU engine tokenizes the input sentence into “please”, “call” and “Kim Cheol-su”. The NLU engine determines from the tokens that the intent of the input sentence is to “make a phone call.” The slot for the utterance intent is “call target.” In this case, the NLU engine may extract “Kim Cheol-su”as the keyword.

As another example, if the input sentence is “Turn on an air conditioner,” the speaker's intended meaning is “Air Conditioner Power On,” and the slots corresponding to the speaker's intended meaning are “temperature and fan speed.”

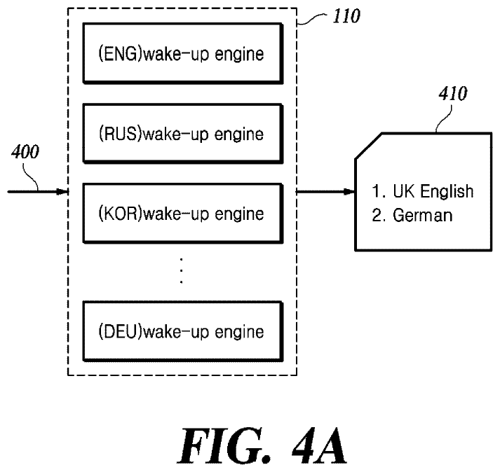

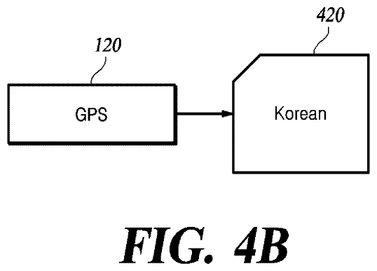

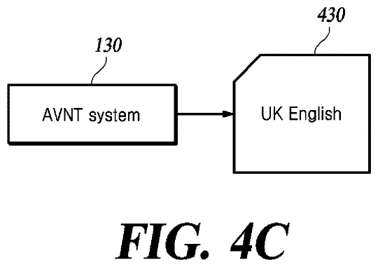

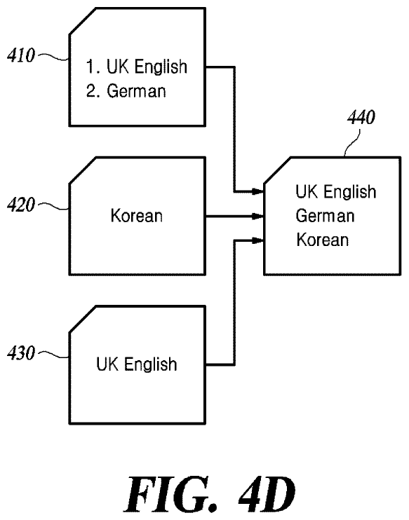

FIG. 4A is a block diagram illustrating an operation in which the wake-up engine 110 is activated to select a first candidate language 410 according to one embodiment of the present disclosure.

The wake-up engine 110 may learn a specific pronunciation and speech pattern for each language. For example, a Korean wake-up engine and an English wake-up engine may be trained to recognize “Hey Hyundai”with different pronunciations.

The wake-up engine 110 may receive a user's first speech utterance 400. The wake-up engine 110 may recognize the wake-up word among the contents of the first speech utterance 400 uttered by the user. For example, when receiving the speech “Hey Hyundai, What's up”, the English wake-up engine and the Korean wake-up engine each may recognize the wake-up word spoken by the user, i.e., “Hey Hyundai”, based on their respective learning data. Each engine may assign a confidence score based on how closely the received speech matches the pronunciation of the language it has learned. The confidence score may be a score indicating how accurately the wake-up engine 110 recognized the speech data. The confidence score may be typically expressed as a value between 0 and 1. The higher the value, the more confident the system is that the speech is correct. For example, the Korean wake-up engine may give a high confidence score to the speech utterance pronounced as “Hey, Hyundai.” However, if the English wake-up engine receives the pronunciation of the same speech utterance, the English wake-up engine may assign a low confidence score. Further, the wake-up engine 110 may be trained to distinguish subtle differences in pronunciation between languages. For example, if a German speaker pronounces “Hey Hyundai” in English, the English wake-up engine may give a lower confidence score to the German speaker's pronunciation compared to that of the English speaker. This is because the pronunciation of the German speaker is subtly different from the learning data of the English wake-up engine. Conversely, a German wake-up engine may assign a higher confidence score when the same pronunciation is made by the German speaker.

Therefore, the wake-up engine 110 may receive the first speech utterance 400 and may select the first candidate language 410 based on the confidence score that is the result of the wake-up engine recognizing the wake-up word for each language. There may be multiple first candidate languages depending on the confidence score. For example, the language with the highest confidence score may be selected first, and multiple candidate languages may be selected.

FIG. 4B is a block diagram illustrating an operation in which the GPS 120 is activated to select a second candidate language 420 according to one embodiment of the present disclosure. To explain FIG. 4B, reference may be also made FIG. 2.

The vehicle 10 may use the GPS 120 to determine which country the user is currently located in.

The vehicle 10 may select the second candidate language 420 based on the language of the country in which the user is located, on the basis of the current location information.

For example, if the current location of the vehicle 10 is Korea, the language of the current country is checked based on the GPS 120 and the second candidate language 420 is selected.

When the vehicle 10 moves from the country in which the vehicle 10 is currently located to a neighboring country, the vehicle 10 may determine its current location in real-time based on the GPS 120, may check the language of the country the vehicle 10 has moved to, and may select a new second candidate language 420.

When the user crosses a border between countries in the vehicle, the real-time language changing system 1 may suggest the language of the country and may adjust a user interface appropriately, thereby greatly improving user convenience.

FIG. 4C is a block diagram illustrating an operation in which the AVNT system 130 is activated to select a third candidate language 430 according to one embodiment of the present disclosure. To explain FIG. 4C, reference may also be made to FIG. 2.

The AVNT system 130 may be (e.g., automatically) activated when the vehicle 10 is started.

The AVNT system 130 may check the language setting that is currently in used in the infotainment system within the vehicle 10.

The AVNT system 130 may provide a function that allows the user to set the language of the system. Therefore, the user may check the language currently set in the AVNT system 130 and may change it to a language desired by the user. The vehicle 10 may select a third candidate language based on the language that is currently set in the AVNT system 130.

FIG. 4D is a block diagram illustrating an operation in which the vehicle 10 selects a finally set candidate language 440 according to one embodiment of the present disclosure. To explain FIG. 4D, reference may be also made to FIGS. 2 and 3.

The vehicle 10 may select candidate languages 440 to be transmitted to the server 20. The vehicle 10 may synthesize the candidate languages 410, 420, and 430 selected from the wake-up engine 110, the GPS 120, and the AVNT system 130 to finally select the candidate languages 440. In other words, the candidate languages 440 may be selected based on at least one of the wake-up word spoken by the user, the location of the vehicle, or the language setting of the vehicle. Thus, by providing only the recognition results of the speech recognition engines according to the default language of the wake-up engine 110, GPS 120, and AVNT system 130 and setting the language of the provided results as the default language, a computation amount required to change the default language may be reduced.

Further, by using the finally selected candidate language 440, the user may easily adjust the language interface of the vehicle 10 without complex settings, significantly enhancing user convenience.

The vehicle 10 may suggest the optimal language to the server 20. The vehicle 10 may transmit information about a user's second speech utterance 500 and the candidate languages 440 selected by the vehicle 10 to the server 20.

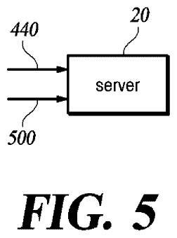

FIG. 5 is a block diagram illustrating an operation in which the server 20 processes the candidate language 440 from the vehicle 10 according to one embodiment of the present disclosure. To explain FIG. 5, reference may also be made to FIG. 1.

The vehicle 10 may transmit information about a user's second speech utterance 500 and the final candidate languages 440 selected by the vehicle 10 to the server 20. The server 20 may analyze the received information and may set the speech recognition language suitable for the user. The server 20 may give priority to languages with high scores based on the confidence score of each language analyzed by the wake-up engine 110. The server 20 may use the location information provided by the GPS 120 to check whether the language of the country where the user is currently located is included in the candidate language 440 and adjust the priority. The server 20 may select the optimal language based on the user's past language setting data and speech usage patterns, allowing the speech recognition system to be set in a language convenient for the user. Further, the vehicle 10 may receive a candidate language-specific response to the user's speech utterance from the server 20. The vehicle 10 may receive a candidate language response from the server 20, and the vehicle 10 may determine whether a certain word or phrase, such as “no” or “go back”, is stated a certain number of (e.g., three) consecutive times in a speech recognition scenario by the user. For example, if the user responds with “no” or “go back” the certain number of (e.g., three) consecutive times to a response or guidance provided by the vehicle 10, the vehicle 10 may prompt the user to change the language. For example, if the user says “no” or “go back” three consecutive times in the speech recognition scenario, the vehicle 10 suggests to the user, “Has a driver changed? Would you like to change the system language?” and induces a change to another language selected from the final candidate languages 440.

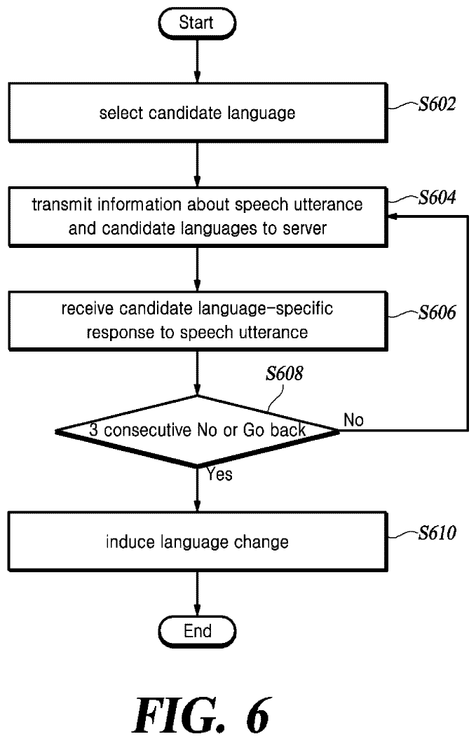

FIG. 6 is a flowchart showing a process of changing a language in real-time according to one embodiment of the present disclosure.

The real-time language changing system 1 may be triggered by at least one of starting the vehicle 10, adjusting a seat, or changing a user's profile. For example, when the vehicle 10 is started, the driver's seat is adjusted, or the user's profile is changed, it may be considered that a change has occurred in the user, i.e. the driver.

The vehicle 10 may select candidate languages 440 to be transmitted to the server 20. The vehicle 10 may synthesize the candidate languages 410, 420, and 430 selected from the wake-up engine 110, the GPS 120, and the AVNT system 130 to finally select the candidate languages 440 in a step or operation S602. In other words, the candidate languages 440 may be selected based on at least one of the wake-up word spoken by the user, the location of the vehicle, or the language setting of the vehicle.

In a step or operation S604, the vehicle 10 may transmit information about the user's second speech utterance 500 and the final candidate languages 440 selected by the vehicle 10 to the server 20. The server 20 may analyze the received information and may set the speech recognition language suitable for the user.

In a step or operation S606, the vehicle 10 may receive a candidate language-specific response to the user's speech utterance from the server 20.

In a step or operation S608, the vehicle 10 may determine whether a certain word or phrase, such as “no” or “go back”, is stated by the user a certain number of consecutive times (e.g., three consecutive times) in a speech recognition scenario.

If the user says “no” or “go back” the certain number (e.g., three) consecutive times in the speech recognition scenario—for example, if the user responds with “no” or “go back” three times in a row to the responses or guidance provided by the vehicle 10—the vehicle 10 may prompt the user to change the language in a step or operation S610. For example, if the user says “no” or “go back” three consecutive times in the speech recognition scenario, the vehicle 10 suggests to the user, “Has a driver changed? Would you like to change the system language?” and induces a change to another language selected from the final candidate languages 440. Further, if the candidate language selected by the user is different from the language currently set in the vehicle, the language set in the vehicle may be changed to the candidate language selected by the user. Therefore, the real-time language changing system 1 has the effect of providing customized services tailored to the user's language as well as the user's preferences and driving habits, and providing a personalized experience.

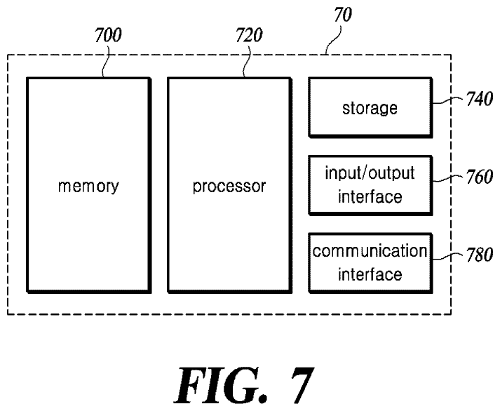

FIG. 7 is a block diagram schematically illustrating an example computing device that may be used to implement a method or device according to the present disclosure.

The computing device 70 may include some or all of a memory 700, a processor 720, a storage 740, an input/output interface 760, and a communication interface 780. The computing device 70 may be a stationary computing device such as a desktop computer or a server as well as a mobile computing device such as a laptop computer or a smart phone. The computing device 70 may include any specialized hardware accelerator capable of processing operations for an artificial intelligence model in an efficient manner. For example, the computing device 70 may include a graphic processing unit (GPU), a tensor processing unit (TPU), or a neural processing unit (NPU).

The memory 700 may store a program that causes the processor 720 to perform a method or operation according to various embodiments of the present disclosure. For example, the program may include a plurality of computer-readable instructions executable by the processor 720, and the above-described method or operations may be performed by executing the plurality of instructions by the processor 720. The memory 700 may be a single memory or multiple memories. In this case, information required to perform the method or operation according to various embodiments of the present disclosure may be stored in the single memory or be separately stored in the multiple memories. When the memory 700 is composed of multiple memories, the multiple memories may be physically separated. The memory 700 may include at least one of a volatile memory and a non-volatile memory. The volatile memory includes a Static Random Access Memory (SRAM) or a Dynamic Random Access Memory (DRAM), and the non-volatile memory includes a flash memory.

The processor 720 may include at least one core capable of executing at least one instruction. The processor 720 may execute instructions stored in the memory 700. The processor 720 may be a single processor or multiple processors.

The storage 740 maintains stored data even when power supplied to the computing device 70 is cut off. For example, the storage 740 may include the non-volatile memory, or may include storage media such as magnetic tape, optical disks, or magnetic disks. A program stored in the storage 740 may be loaded into the memory 700 before being executed by the processor 720. The storage 740 may store a file written in a programming language, and a program generated from the file by a compiler or the like may be loaded into the memory 700. The storage 740 may store data to be processed by the processor 720 and/or data processed by the processor 720.

The input/output interface 760 may provide an interface with an input device such as a keyboard or a mouse, and/or an output device such as a display device or a printer. The user may trigger the execution of a program by the processor 720 through an input device and/or check the processing result of the processor 720 through an output device.

The communication interface 780 may provide access to an external network. The computing device 70 may communicate with other devices via the communication interface 780.

Each element of the apparatus or method may be implemented in hardware or software, or a combination of hardware and software. The functions of the respective elements may be implemented in software, and a microprocessor can be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various implementations can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium or media.”

A computer-readable recording medium or media includes any type of recording device that stores data that can be read by a computer system. Such a computer-readable recording medium or media may be a non-volatile or non-transitory medium, such as a ROM, CD-ROM, magnetic tape, floppy disk, memory card, hard disk, optical magnetic disk, or storage device, and may further include a transitory medium, such as a data transmission medium. The computer-readable recording medium or media may also be distributed across a networked computer system, such that the computer-readable code is stored and executed in a distributed manner.

Although operations are illustrated in the flowcharts/timing charts in this specification as being sequentially performed, this is merely an illustrative description of the technical idea of some embodiments of the present disclosure. Those having ordinary skill in the art to which the present disclosure pertains may appreciate that various modifications and changes may be made without departing from essential features of embodiments of the present disclosure. For example, the sequence illustrated in the flowcharts/timing charts may be changed and one or more operations of the operations may be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed present disclosure. Therefore, the embodiments of the present disclosure have been described for the sake of brevity and clarity. The scope of the technical idea of the present disclosure is not limited by the illustrations. Accordingly, one of ordinary skill in the art should understand that the scope of the claimed present disclosure is not to be limited by the above explicitly described embodiments but by the claims and equivalents thereof.

What is claimed is:

1. A real-time language changing method performed by a computing device comprising at least one processor, the method comprising:
selecting candidate languages based on at least one of a wake-up word uttered by a user, a location of a vehicle, or language setting of the vehicle;
transmitting information about a speech utterance of the user and the candidate languages to a server;
receiving a candidate language-specific response to the speech utterance of the user from the server; and
changing the language setting of the vehicle based on a selection made by the user for the candidate language-specific response.

2. The method of claim 1, wherein selection of the candidate languages is triggered by at least one of the vehicle being started, a seat in the vehicle being adjusted, or a user profile being changed.

3. The method of claim 1, wherein selecting the candidate languages includes selecting one or more first candidate languages based on respective confidence scores assigned by a wake-up engine to results of recognizing the wake-up word for each language among a plurality of languages.

4. The method of claim 1, wherein selecting the candidate languages includes selecting a second candidate language based on a language of a country in which the user is located, wherein the language of the country is determined based on current location information of the vehicle.

5. The method of claim 1, wherein selecting the candidate languages includes selecting a third candidate language based on a language that is currently set in the vehicle.

6. The method of claim 1, wherein changing the language setting of the vehicle based on the selection made by the user for the candidate language-specific response includes changing the language set in the vehicle to a candidate language selected by the user based on determining that the candidate language selected by the user is different from the language set in the vehicle.

7. The method of claim 1, further comprising prompting the user to make the selection for the candidate language-specific response based on determining that the user states a particular word or phrase a certain number of consecutive times in response to the candidate language-specific response.

8. A device comprising:
at least one memory configured to store computer-readable instructions; and
at least one processor configured to execute the computer-readable instructions to:
select candidate languages based on at least one of a wake-up word uttered by a user, a location of a vehicle, or language setting of the vehicle,
transmit information about a speech utterance of the user and the candidate languages to a server,
receive a candidate language-specific response to the speech utterance of the user from the server, and
change the language setting of the vehicle based on a selection made by the user for the candidate language-specific response.

9. The device of claim 8, wherein the at least one processor is configured to trigger selecting of the candidate languages in response to at least one of the vehicle being started, a seat in the vehicle being adjusted, or a user profile being changed.

10. The device of claim 8, wherein the at least one processor is configured to select one or more first candidate languages based on respective confidence score assigned by a wake-up engine to respective results of recognizing the wake-up word for each language among a plurality of languages.

11. The device of claim 8, wherein the at least one processor is configured to select a second candidate language based on a language of a country in which the user is located, wherein the language of the country is determined based on current location information of the vehicle.

12. The device of claim 8, wherein the at least one processor is configured to select a third candidate language based on a language that is currently set in the vehicle.

13. The device of claim 8, wherein the at least one processor is configured to change the language setting of the vehicle based on the selection made by the user for the candidate language-specific response by changing the language set in the vehicle to a candidate language selected by the user based on determining that the candidate language selected by the user is different from the language set in the vehicle.

14. The device of claim 8, wherein the at least one processor is configured to prompt the user to make the selection for the candidate language-specific response based on determining that the user states a particular word or phrase a certain number of consecutive times in response to the candidate language-specific response.

15. A non-transitory recording medium or media storing computer-readable instructions that, when executed by at least one processor, cause the at least one processor to:
select candidate languages based on at least one of a wake-up word uttered by a user, a location of a vehicle, or language setting of the vehicle;
transmit information about a speech utterance of the user and the candidate languages to a server;
receive a candidate language-specific response to the speech utterance of the user from the server; and
change the language setting of the vehicle based on a selection made by the user for the candidate language-specific response.

16. The non-transitory recording medium or media of claim 15, wherein the computer-readable instructions, when executed by the at least one processor, cause the at least one processor to trigger selection of the candidate languages in response to at least one of the vehicle being started, a seat in the vehicle being adjusted, or a user profile being changed.

17. The non-transitory recording medium or media of claim 15, wherein the computer-readable instructions, when executed by the at least one processor, cause the at least one processor to select one or more first candidate languages based on respective confidence score assigned by a wake-up engine to respective results of recognizing the wake-up word for each language among a plurality of languages.

18. The non-transitory recording medium or media of claim 15, wherein the computer-readable instructions, when executed by the at least one processor, cause the at least one processor to select a second candidate language based on a language of a country in which the user is located, wherein the language of the country is determined based on current location information of the vehicle.

19. The non-transitory recording medium or media of claim 15, wherein the computer-readable instructions, when executed by the at least one processor, cause the at least one processor to select a third candidate language based on a language that is currently set in the vehicle.

20. The non-transitory recording medium or media of claim 15, wherein the computer-readable instructions, when executed by the at least one processor, cause the at least one processor to change the language setting of the vehicle by changing the language set in the vehicle to a candidate language selected by the user based on determining that the candidate language selected by the user is different from the language set in the vehicle.
